(19) United States
(12) Patent Application Publication
(10) Pub. No.: US 2015/0149459 A1
(43) Pub. Date: May 28, 2015

(54) Tag Based System For Leveraging Design Data

(71) Applicant: Mentor Graphics Corporation, Wilsonville, OR (US)

(72) Inventors: Nigel Hughes, Newbury Berkshire (GB); Artem Kornilov, Portland, OR (US)

(21) Appl. No.: 14/549,224

(22) Filed: Nov. 20, 2014

Related U.S. Application Data
(60) Provisional application No. 61/907,862, filed on Nov. 22, 2013.

(51) Int. Cl. G06F 17/30; G06F 17/50

(52) U.S. Cl. CPC G06F 17/30525; G06F 17/50
USPC 707/736

(57) ABSTRACT

This application discloses a computing system implementing one or more tools or mechanism configured to integrate different design stages, phases, or levels of abstraction by relating objects based on one or more of their characteristics, such as physical or electrical attributes, properties, references, or the like. The tools or mechanism can generate tags corresponding to characteristics of objects in one or more designs representing at least a portion of an electronic system. The tools or mechanism can link the objects in the one or more designs based, at least in part, on tags, and, in response to receiving a selection corresponding to a portion of the one or more designs, present information corresponding to at least another portion in the one or more designs associated with the selected portion based, at least in part, on the linked objects.

### RELATED APPLICATION

This application claims priority to U.S. Provisional Patent Application No. 61/907,862, filed Nov. 22, 2013, which is incorporated by reference herein.

### TECHNICAL FIELD

This application is generally related to electronic design automation and, more specifically, to a tag based system for leveraging design data.

### BACKGROUND

The design of electrical and electronic systems or interconnects, such as wiring harnesses, for example, for implementation into vehicles, aircraft, boats, appliances, or other systems with distributed electronics, can include many different design stages or phases at different levels of abstraction. For example, some of the design phases can include a requirements phase, a functional phase, a logical phase, a physical or wiring phase, a components phase, which can include at least one of a topology section, a harness section, or the like, a formboard or manufacturing phase, and a service phase.

While traversing these various design phases can allow for development and implementation of a wiring harness, practically speaking, a majority of the design activity involves adjustment to existing designs. Some of the adjustments may be made to add new functionality to an existing design, i.e., adding new electrical ports allowing connection of the wiring harness to a new peripheral, to satisfy a new requirement, to switch to a different type of part available during manufacture, or the like. To understand the impact of any design change made at one abstraction or phase of the design on other abstractions or phases of the design, conventional design processes attempt to propagate the change forward in the design process. Since this is often time-consuming, many design teams often rely on human intuition to sign-off on a design change rather than re-perform the whole analysis. Design changes made late in the design process can be difficult to propagate to earlier design stages, such as the requirements phase, in conventional design flows.

### SUMMARY

This application discloses a computing system implementing one or more tools or mechanism configured to integrate the different design stages, phases, or levels of abstraction by linking or relating objects based on one or more of their characteristics, such as physical or electrical attributes, properties, references, or the like. The tools and mechanisms can view design data from these different design stages as a set of objects with tags representing information about the objects including their interrelationships. The tools and mechanisms can infer relationships between objects by querying and processing these tags. The tools and mechanisms can utilize the object interrelationships to trace relationships, navigate related objects, compare objects, synchronize objects, and so on.

In some embodiments, the tools or mechanism can generate tags corresponding to characteristics of objects in one or more designs representing at least a portion of an electronic system. The tools or mechanism can link the objects in the one or more designs based, at least in part, on tags, and, in response to receiving a selection corresponding to a portion of the one or more designs, present information corresponding to at least another portion in the one or more designs associated with the selected portion based, at least in part, on the linked objects. The information presented can include a tracing report, an impact assessment report, or the like. These and other embodiments will be described below in greater detail.

### DESCRIPTION OF THE DRAWINGS

FIGS. 1 and 2 illustrate an example of a computer system of the type that may be used to implement various embodiments of the invention.

FIGS. 3A and 3B illustrate an example platform design system according to various embodiments of the invention.

FIG. 4 illustrates an example of a platform design analysis tool to correlate designs representing an electronic system at different levels of abstraction, which may be implemented according to various embodiments of the invention.

FIG. 5 illustrates a flowchart showing example operation of a platform design analysis tool according to various examples of the invention.

FIGS. 6A and 6B illustrate an example implementation of a tagging service implemented in a platform design analysis tool according to various examples of the invention.

FIGS. 7A and 7B illustrate another example implementation of the tagging service implemented in a platform design analysis tool according to various examples of the invention.

FIG. 8 illustrates a flowchart showing example tagging and indexing of designs in the platform design flow according to various examples of the invention.

FIG. 9 illustrates an example implementation of a comparison service implemented in the platform design analysis tool according to various examples of the invention.

FIG. 10 illustrates a flowchart showing example operation of the comparison service and a synchronization service in a platform design analysis tool according to various examples of the invention.

### DETAILED DESCRIPTION

### Illustrative Operating Environment

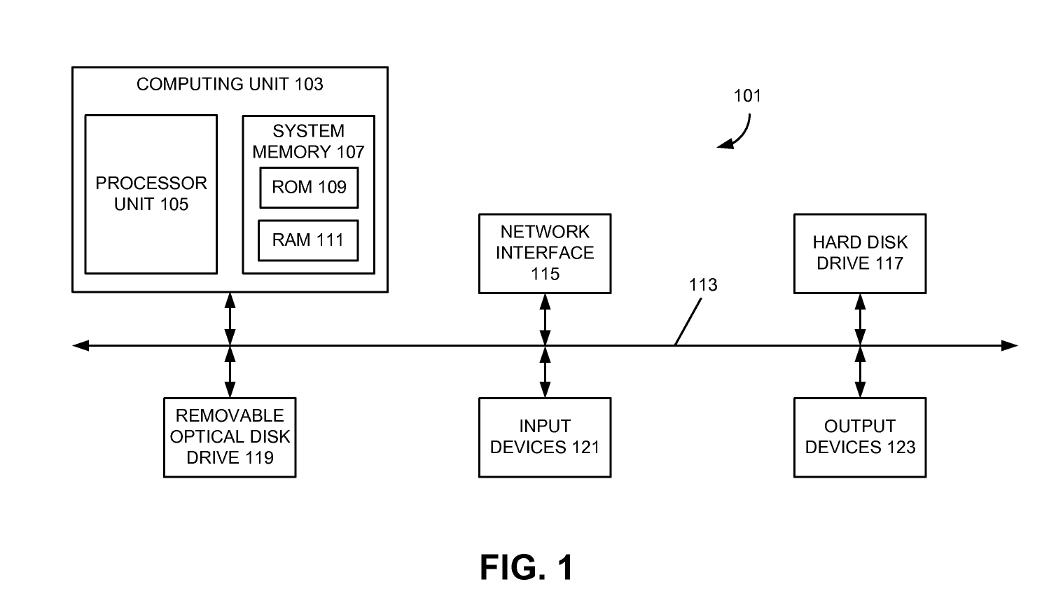

The execution of various design processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some processes and the large size of many designs, various design tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

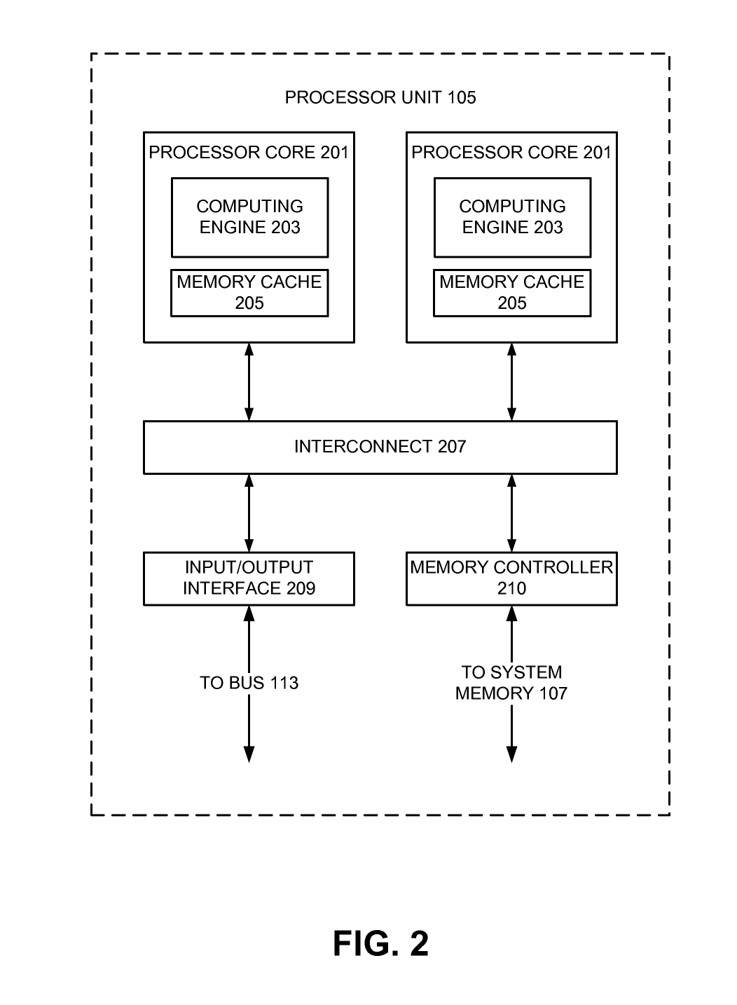

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Illustrative Platform Design System

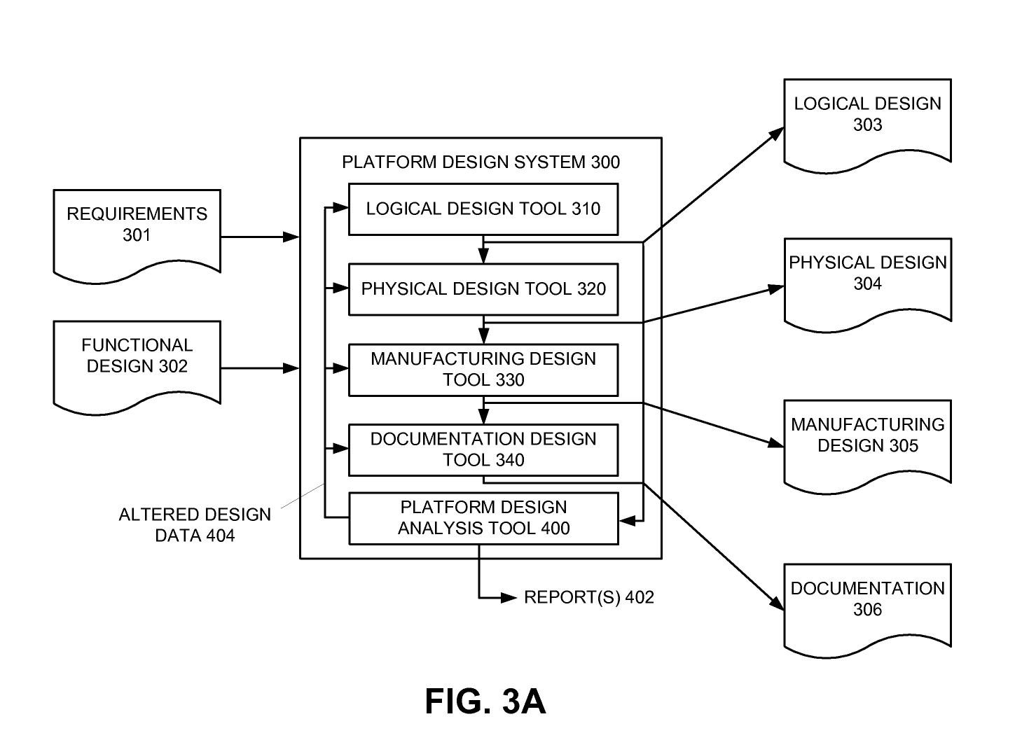

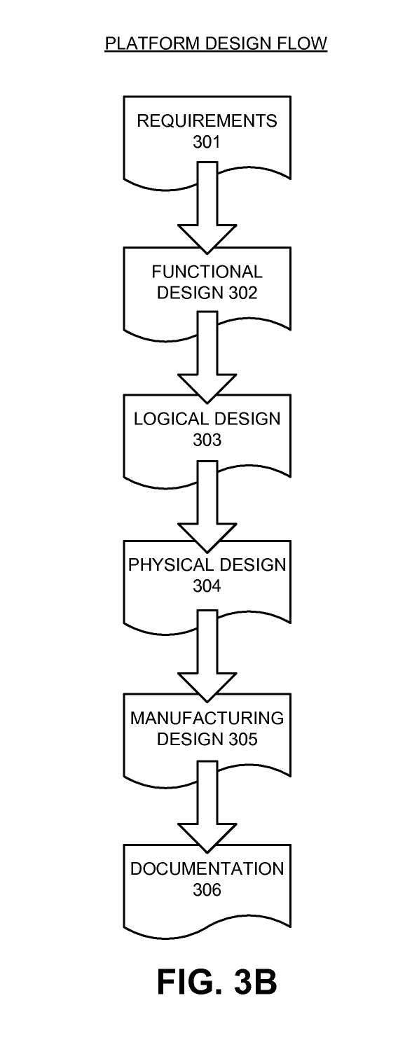

FIGS. 3A and 3B illustrate an example platform design system 300 according to various embodiments of the invention. Referring to FIGS. 3A and 3B, the platform design system 300 can include a set of one or more tools to develop at least a portion of an electronic system, such as a wiring harness. The development of the electronic system can be performed utilizing a platform design flow that includes multiple design stages, each representing the electronic system at a different level of abstraction.

The platform design flow can initially describe the electronic system as a set of requirements 301, for example, aspects, objectives, high-level operations, or the like, for the electronic system. The requirements 301 can be converted into a functional design 302, which can functionally describe the electronic system. The platform design flow continues by generating a logical design 303 for the electronic system. The logical design 303 can describe the connectivity and devices capable of implementing the functionality of the electronic system, for example, specified as a netlist or the like. The platform design flow can then include a physical design 304 that, in a wiring harness example, can describe the wires and components to physically implement the logical design 303. The platform design flow can then include a manufacturing design 305 that, in a wiring harness example, can describe specific harness components, such as mechanical structures, connectors, wire splices, or the like, as well as manufacturing aids, such as form boards, manufacturing tools, or the like. The platform design flow can include documentation 306 to describe manufacturing instructions, service or diagnostic information, decommissioning information, or the like, for the electronic system.

The platform design system 300 can include a logical design tool 310 to generate a logical design 303 for the electronic system, for example, based at least in part on the requirements 301 and the functional design 302 for the electronic system. In some embodiments, the logical design 303 can be a netlist for the electronic system, which can describe the connectivity and devices capable of implementing the functionality of the electronic system. The logical design tool 310 can receive the requirements 301 and the functional design 302 from a device external to the platform design system 300 or, in some embodiments, the platform design system 300 can include other tools (not shown) that can build or generate the requirements 301 and the functional design 302 for the electronic system.

The platform design system 300 can include a physical design tool 320 to generate a physical design 304 based, at least in part, on the logical design 303. The physical design 304, in a wiring harness example, can describe the wires and components to physically implement the logical design 303.

The platform design system 300 can include a manufacturing design tool 330 to generate a manufacturing design 305 based, at least in part, on the physical design 304. The manufacturing design 305, in the wiring harness example, can describe specific harness components, such as mechanical structures, connectors, wire splices, or the like, as well as manufacturing aids, such as form boards, manufacturing tools, or the like.

The platform design system 300 can include a documentation design tool 340 to generate a documentation 306 based, at least in part, on the manufacturing design 305. The documentation 306, in the wiring harness example, can describe manufacturing instructions, service or diagnostic information, decommissioning information, or the like, for the electronic system.

The platform design system 300 can include a platform design analysis tool 400 to analyze the requirements 301, the functional design 302, the logical design 303, the physical design 304, the manufacturing design 305, and/or the documentation 306, and automatically link them to each other across their levels of abstraction. Based on this linking, the platform design analysis tool 400 can generate reports 402, such as requirements tracking, impact assessment, or the like.

The platform design analysis tool 400 also can further analyze the linked designs, for example, by comparing two or more of the designs based on their linking for verification purposes, such as equivalence checking, design rule checking, or the like. Based on this comparison, the platform design analysis tool 400 can generate one or more of the reports 402, such as deltas that can describe differences between the compared designs and, in some embodiments, identifying alterations to one or more of the designs that could synchronize the compared designs.

The platform design analysis tool 400 also can automatically perform the identified synchronization, which can generate altered design data 404 capable of being provided to a corresponding tool in the platform design system. In some embodiments, the deltas can be executable, which can allow the platform design analysis tool 400 to automatically synchronize the compared designs described in the executable delta, for example, in response to a user input. Embodiments of the platform design analysis tool 400 will be described below in greater detail.

### Illustrative Platform Design Analysis Tool

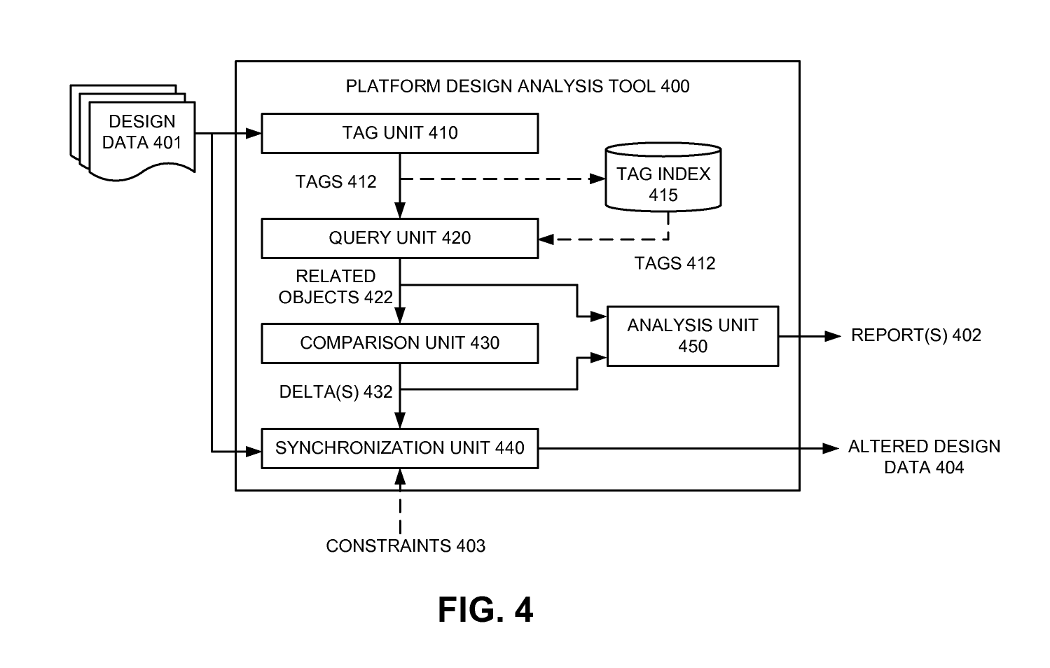

FIG. 4 illustrates an example of a platform design analysis tool 400 to correlate designs representing an electronic system at different levels of abstraction, which may be implemented according to various embodiments of the invention. Referring to FIG. 4, the platform design analysis tool 400 can include a tag unit 410 to receive design data 401 that includes multiple designs representing the electronic system at different levels of abstraction. For example, the design data 401 can include requirements for the electronic system, a functional design for the electronic system, a logical design for the electronic system, a physical design for the electronic system, a manufacturing design for the electronic system, and/or documentation for the electronic system.

The tag unit 410 can identify objects in the design data 401, determine characteristics of the identified objects, and generate one or more tags 412 for the objects based on the characteristics. The objects in the design data 401 can be any portion of the design, such as wires, functions, nets, parts, components, harness structures, or the like. For example, when the design data 401 includes a logical design, the tag unit 410 can identify each net in the logical design as an object. In another example, when the design data 401 includes a physical design, the tag unit 410 can identify each wire in the physical design as an object. The characteristics of the objects can vary depending on which design abstraction the objects are associated with, but can include which endpoints are coupled to the object, what function the object performs, which net is associated with the object, which wire(s) or component(s) implements the object, what are the characteristics of those wire(s) or component(s), such as color, weight, gauge, part number, or the like, which harness or subsystem is associated with the wire(s) or component(s), or the like. The platform design analysis tool 400 can include a tag index 415 to store the tags 412 generated by the tag unit 410. Examples of tag generation by the platform design analysis tool will be described below in greater detail.

The platform design analysis tool 400 can include a query unit 420 to identify relationships between the tags 412, which can define sets of related objects 422 in the design data 401. In some embodiments, the query unit 420 can receive the tags 412 from the tag unit 410 or access them from the tag index 415. Since one or more of sets of the related objects 422 can include objects from different designs that represent the electronic system at different levels of abstraction, the query unit 420 can link designs in the design data 401 based on the sets of the related objects 422.

Since the tags can describes many different characteristics of objects in the design data 401, the query unit 420 can relate the tags 412 based on a selectable subset including one or more of the characteristics. In some embodiments, the query unit 420 can identify relationships between the tags 412 dynamically, for example, by querying the tag index 415, which can alleviate the platform design analysis tool 400 from having to predetermine and store all the relationships between objects in the design data 401.

The platform design analysis tool 400 can include a comparison unit 430 to utilize the related objects 422 to compare multiple designs in the design data 401 representing the electronic system at different levels of abstraction. Based on the comparison, the comparison unit 430 can generate one or more deltas 432, which can identify differences between the compared designs. The deltas 432, in some embodiments, can be a data structure defining differences between the compared designs, which can range from informalities, such as naming inconsistencies, part or component mismatches, or the like, all the way to design flaws, such as missing objects, incongruent object characteristics, or the like.

The platform design analysis tool 400 can include a synchronization unit 440 to utilize the one or more deltas 432 to synchronize the compared designs. The synchronization unit 440 can perform the synchronization, which can generate altered design data 404 for the platform design system. In some embodiments, the deltas 432 can be executable, which can allow the synchronization unit 440 to automatically synchronize the compared designs described in the executable delta, for example, in response to a user input. In some embodiments, the synchronization unit 440 can perform the synchronization by synthesizing or generating at least a portion of a design at one level of abstraction based on a design at a different level of abstraction. Since synthesis of one design into another design often can be performed in a variety of ways, the synchronization unit 440, in some embodiments, can receive constraints 403, which help guide synthesis operations performed by the synchronization unit 440.

The platform design analysis tool 400 can include an analysis unit 450 to generate one or more reports 402 based on the related objects 422 from the query unit 420 and/or the deltas 432 from the comparison unit 430. In some embodiments, the analysis unit 450 can prompt or direct the query unit 420 to determine the related objects 422 from tags 412 and generate the reports 402 from the related objects 422 and/or the associated deltas 432. While the analysis unit 450 can generate all manner of reports 402 from the related objects 422 and or deltas 432, several will be described below as an illustrative implementation of the analysis unit 450.

In some embodiments, the analysis unit 450 can generate a tracing report, which can trace where a requirement or other feature or portion in one design is represented at a different level of abstraction in another design. As way of example, for a requirement tracing report, the analysis unit 450 can identify which portions of the design data 401 implement one or more requirements in the design data 401 and generate a report 402 with the results. In some examples, the requirements tracing report 402 can be requirement-driven, e.g., identifying portions of the design data 401 that implement a specific requirement, or it can be design-driven, e.g., identifying which requirements were implemented by a specific portion of the design data 401. Since the analysis unit 450 can determined how a requirement was implemented in the design data 401 across multiple levels of abstraction, the analysis unit 450 also can generate a report that shows or describes a path or trace via links between the designs in each level of abstraction that implement a requirement and how they are linked.

In some embodiments, the analysis unit 450 can generate an impact report, which can estimate an impact of a change to the electronic system in response to a change to at least one of the designs. For example, when a change is made to one of the designs in the design data 401, the analysis unit 450 can identify which portions of the other designs at different levels of abstraction would be affected if that change was propagated to the other designs. The analysis unit 450 can identify which portions of the other designs are related to the change in the design based on the related objects 422 and determine how to change the portions of the other designs in order to make all of the designs congruent. The analysis unit 450 can then determine a “cost” for implementing the change across all of the designs, which can include financial cost, time-to-market cost, time-to-manufacture cost, part supplier augmentation cost, engineering trade-offs cost, etc.

In some embodiments, the analysis unit 450 can generate an equivalency report based, at least in part, on the deltas 432, which can identify whether two or more designs at different levels of abstraction in the design data 401 are equivalent to each other. The analysis unit 450 can review the deltas 432 to determine differences, if any, between the two or more designs and generate an equivalence report based on the deltas 432. For example, when the comparison unit 430 generates no deltas 432 or deltas 432 with formality differences, the analysis unit 450 can generate an equivalence report indicating that the two or more designs are equivalent.

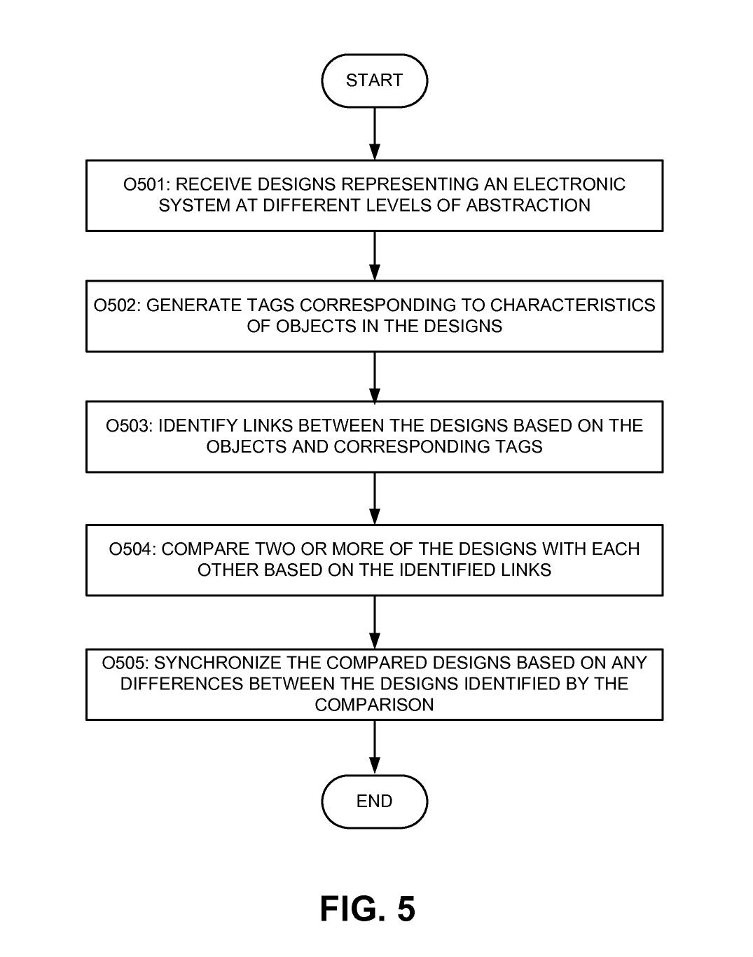

FIG. 5 illustrates a flowchart showing example operation of a platform design analysis tool according to various examples of the invention. Referring to FIG. 5, in a block 501, a platform design analysis tool, for example, implemented by a specifically programmed computing system, can receive designs representing an electronic system at different levels of abstraction. In some embodiments, the designs can include one or more of the designs in the platform design flow, which includes requirements, a functional design, a logical design, a physical design, a manufacturing design, and/or documentation.

In a block 502, the platform design analysis tool can generate tags corresponding to characteristics of objects in the designs. Each of the designs—the requirements, the functional design, the logical design, the physical design, the manufacturing design, and/or the documentation—can include objects, which can corresponding to portions of the designs. For example, in the logical design, each net may be categorized as an object, and the platform design analysis tool can review the logical design to identify characteristics for the nets and generate tags based on the characteristics of the nets in the designs.

In a block 503, the platform design analysis tool can identify links between the designs based on the objects and corresponding tags. The platform design tool, for example, can query a memory system storing the tags to identify which of the objects in designs corresponding to different levels of abstraction relate to each other. The presence of related objects from designs in different levels of abstraction can correspond to a link between those designs. The linking can allow the platform design tool to identify where portions of one design are implemented in another design at a different level of abstraction. For example, the platform analysis tool, based on the linked or related objects, can identify where a function in the functional design is implemented in the logical design, and where that portion of the logical design is implemented in the physical design, etc.

Since the linking of the designs can allow any portion of one design to be traced to any other design, across each level of abstraction, the platform design analysis tool can implement requirements tracing that can identify which requirements were satisfied by any portion of a design at any level of abstraction. The platform design analysis tool also can identify an impact of a change to a design at one level of abstraction on other levels of abstraction. For example, when a change is made to the functional design to remove functionality, the platform design analysis tool can determine whether the functional design implements the requirements, which portions of downstream designs, such as the logical design, physical, manufacturing design, and the like, are affected by the change, and provide a cost or savings estimate if the change were implemented.

In a block 504, the platform design analysis tool can compare two or more of the designs with each other based on the identified links. The platform design analysis tool can compare the designs for verification purposes, such as equivalence checking, design rule checking, or the like. Based on this comparison, the platform design analysis tool can generate one or more of the reports, such as deltas that can describe differences between the compared designs and, in some embodiments, identifying alterations to one or more of the designs that could synchronize the compared designs.

In a block 505, the platform design analysis tool can synchronize the compared designs based on any differences between the designs identified by the comparison. The platform design analysis tool also can automatically perform the identified synchronization, which can generate altered design data capable of being provided to a corresponding tool in the platform design system. In some embodiments, the deltas can be executable, which can allow the platform design analysis tool to automatically synchronize the compared designs described in the executable delta, for example, in response to a user input.

### Illustrative Tagging Service for a Platform Design Analysis Tool

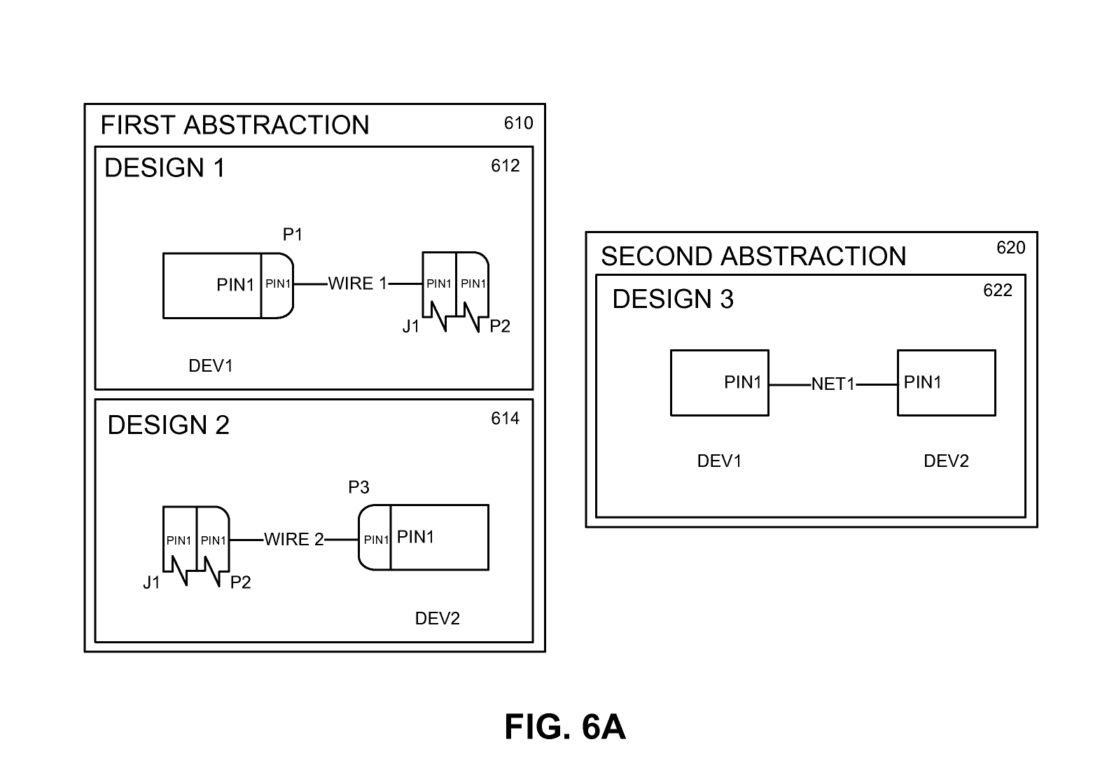

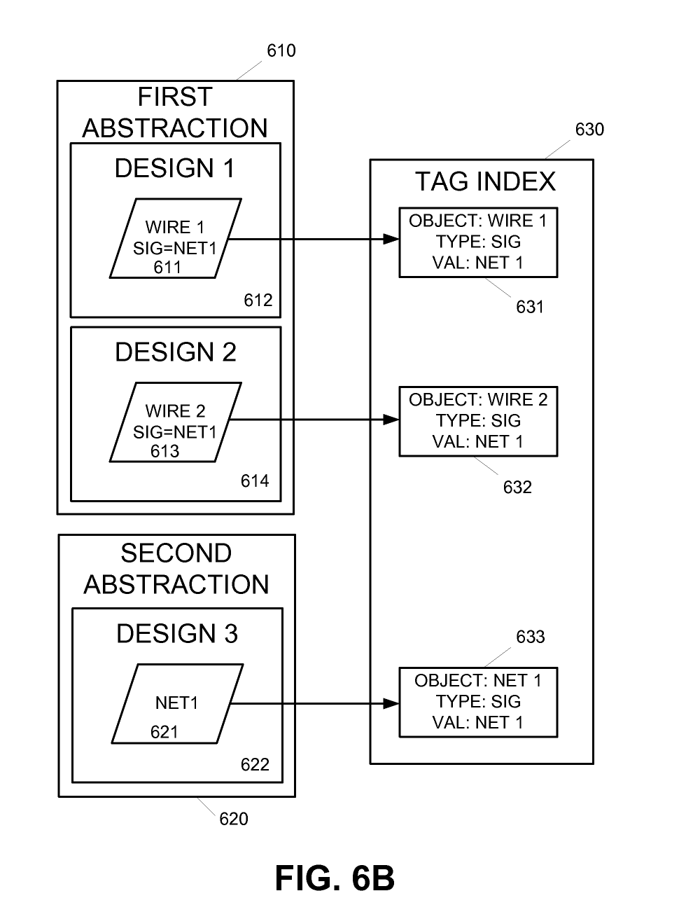

FIGS. 6A and 6B illustrate an example implementation of a tagging service implemented in the platform design analysis tool according to various examples of the invention. Referring to FIG. 6A, the tagging service can tag design data in a straight-forward manner, for example, by identifying objects in the design data, determining characteristics of those objects from the design data, and then generating a tag for the object based on the characteristics.

In this straight-forward tagging example, the design data can include multiple designs representing a portion of an electronic system at different levels of abstraction. For example, a first abstraction 610 can include designs 612 and 614, while a second abstraction 620 can include a design 622. In some embodiments, the first abstraction 610 can be a physical or wiring level of abstraction, while the second abstraction 620 can be a logical level of abstraction. The design 612 shows a first wire WIRE1 coupled between a first pin DEV1 and a junction component J1. The design 614 shows a second wire WIRE2 coupled between a second pin DEV2 and the junction component P2. The design 622 shows a net NET1 coupled between the first pin DEV1 and the second device DEV2.

Referring to FIG. 6B, the tagging service implemented in the platform design analysis tool can identify objects 611, 613, and 621 in the designs 612, 614, and 622, respectively, determine characteristics of the objects 611, 613, and 621 by analyzing the designs 612, 614, and 622, and generate tags 631, 632, and 633 for the objects 611, 613, and 621, respectively, based on the characteristics. For example, the tagging service can generate a tag 631 that identifies the first wire WIRE1 as object 611 in the design 612, which has a characteristic of being a signaling medium for the net NET1. The tagging service can generate a tag 632 that identifies the second wire WIRE2 as object 613 in the design 614, which has a characteristic of being a signaling medium for the net NET1. The tagging service can generate a tag 633 that identifies the net NET1 as object 621 in the design 622. In some embodiments, the tagging service can store the tags 631, 632, and 633 in a tag index 630, for example, residing in a memory device or memory system (not shown).

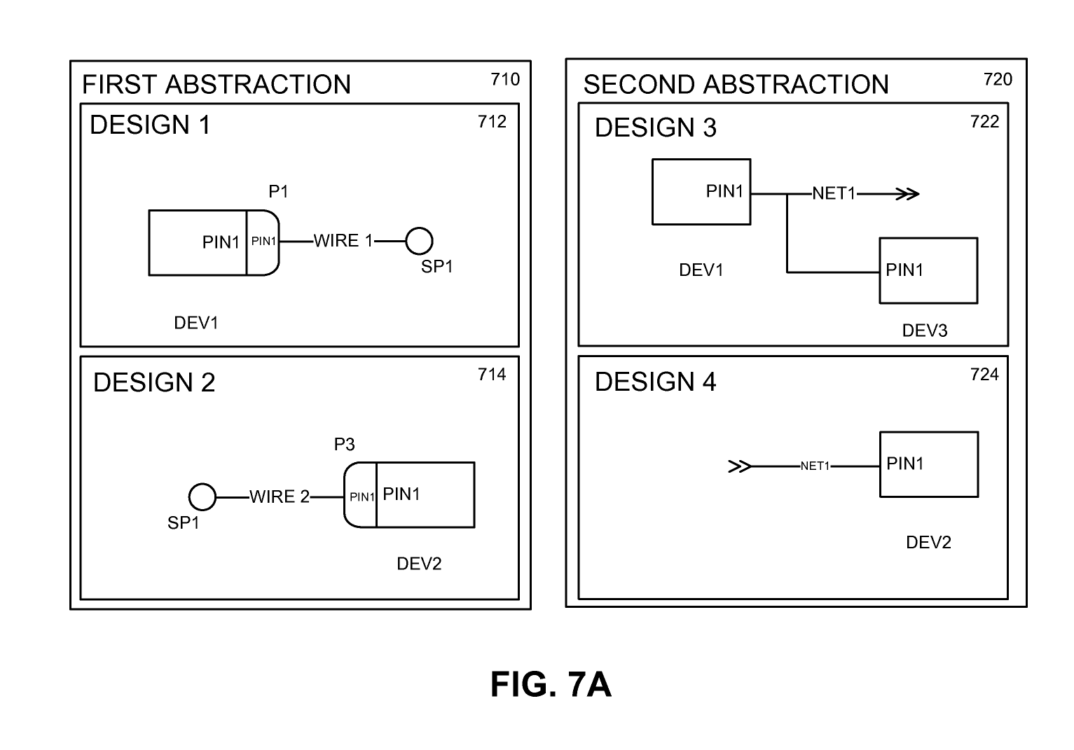

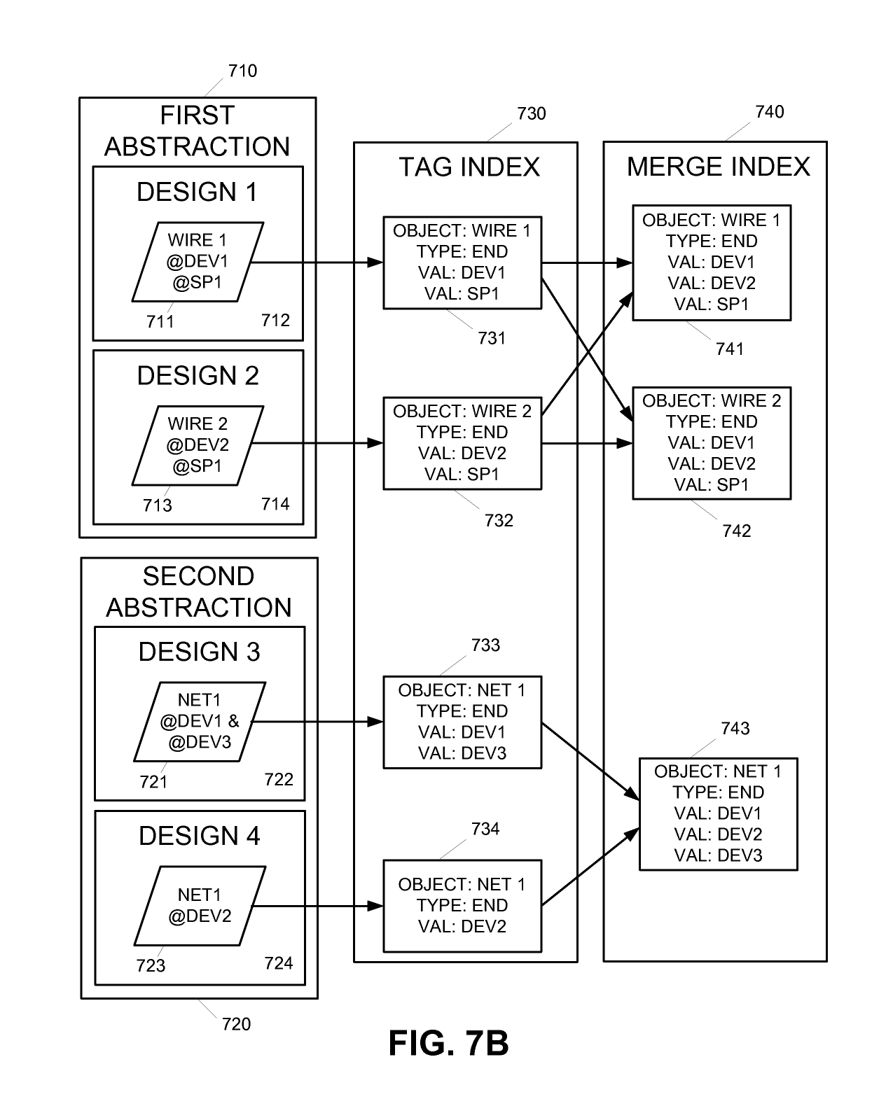

FIGS. 7A and 7B illustrate another example implementation of the tagging service implemented in the platform design analysis tool according to various examples of the invention. Referring to FIG. 7A, the tagging service can tag design data in a more complex or interpretive manner, for example, by identifying objects in the design data, determining characteristics of those objects from the design data, generating a tag for the object based on the characteristics, selectively merging characteristics of tags in a common abstraction into merged tags.

In this more complex tagging example, the design data can include multiple designs representing for a portion of an electronic system at different levels of abstraction. For example, a first abstraction 710 can include designs 712 and 714, while a second abstraction 720 can include designs 722 and 724. In some embodiments, the first abstraction 710 can be a physical or wiring level of abstraction, while the second abstraction 720 can be a logical level of abstraction. The design 712 shows a first wire WIRE1 coupled between a device DEV1 and a splice component SP1. The design 714 shows a second wire WIRE2 coupled between a device DEV2 and the splice component SP1. The design 722 shows a net NET1 having the device DEV1 and the device DEV3 as endpoints. The design 724 shows the net NET1 having the device DEV2 as an endpoints.

Referring to FIG. 7B, the tagging service implemented in the platform design analysis tool can identify objects 711, 713, 721, and 723 in the designs 712, 714, 722, and 724, respectively, determine characteristics of the objects 711, 713, 721, and 723 by analyzing the designs 712, 714, 722, and 724, generate tags 712, 714, 722, and 724 for the objects 711, 713, 721, and 723, respectively, based on the characteristics, and selectively merge characteristics of tags in a common abstraction into merged tags 741, 742, and 743. For example, the tagging service can generate a tag 731 that identifies the first wire WIRE1 as object 711 in the design 712, which has a device DEV1 and the splice component SP1 as endpoints. The tagging service can generate a tag 732 that identifies the second wire WIRE2 as object 713 in the design 714, which has a device DEV2 and the splice component SP1 as endpoints. The tagging service can generate a tag 733 that identifies the net NET1 as object 721 in the design 722, which has the device DEV1 and a device DEV3 as endpoints. The tagging service can generate a tag 734 that identifies the net NET1 as object 723 in the design 724, which has the device DEV2 as an endpoint. In some embodiments, the tagging service can store the tags 731, 732, 733, and 734 in a tag index 730, for example, residing in a memory device or memory system (not shown).

The tagging service can perform one or more merge operations on the tags 731, 732, 733, and 734 to generate the merged tags 741, 742, and 743. For example, the tagging serve can determine tags 731 and 732 correspond to a common abstraction, namely the first abstraction 710, and analyze the tags to determine whether they have common characteristics. In this example, since the tags 731 and 732 each have a common endpoint, namely the splice component SP1, the tagging service can augment the tags 731 and 732 to include an additional endpoint, i.e., so that both tags 731 and 732 include the device DEV1, the device DEV2, and the splice component SP1 as values.

In another merge example, the tagging service can determine tags 733 and 734 correspond to a common abstraction, namely the second abstraction 720, and analyze the tags to determine whether they have common characteristics. In this example, since the tags 733 and 734 each reference a common object, namely the net NET1, the tagging service can merge the tags 733 and 734 into one merged tag 743 includes the device DEV1, the device DEV2, and the third pin DEV3 as values.

In some embodiments, the tagging service can store the tags 731, 732, 733, and 734 in a tag index 730, and store the merged tags 741, 742, and 733 in a merge index 740, which may be a portion of the tag index 730. The tag index 730 and merge index 740 can be stored or otherwise reside in the memory device or memory system (not shown).

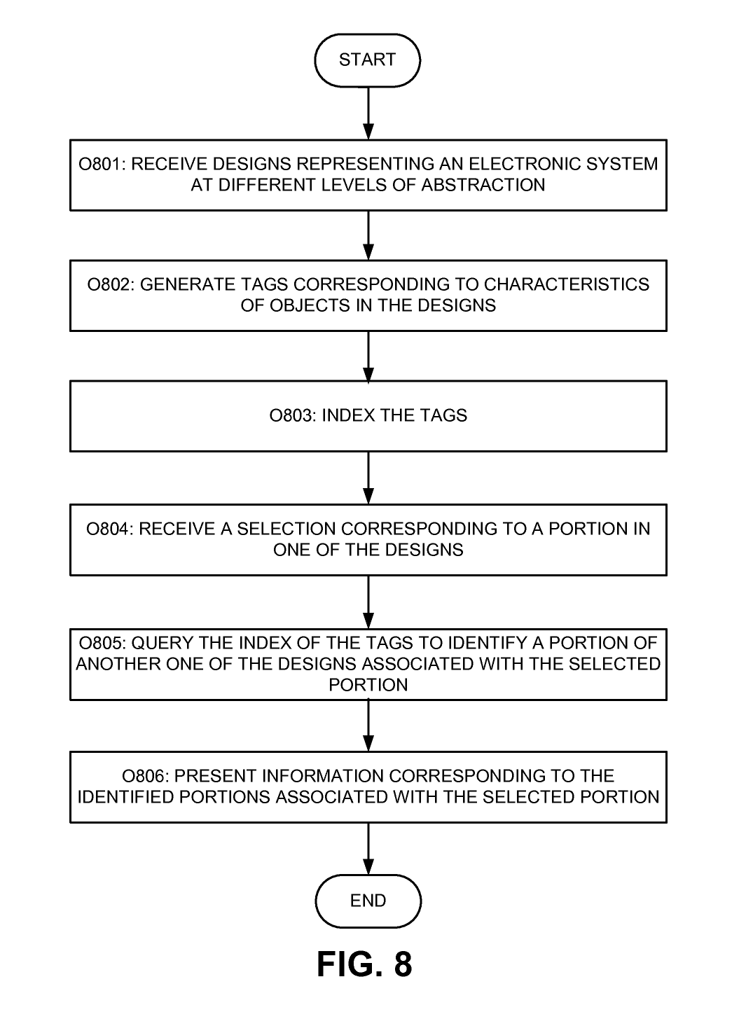

FIG. 8 illustrates a flowchart showing example operation of the tagging service in the platform design analysis tool according to various examples of the invention. Referring in FIG. 8, in a block 801, the platform design analysis tool, for example, implemented by a specifically programmed computing system, can receive designs representing an electronic system at different levels of abstraction. In some embodiments, the designs can include one or more of the designs in the platform design flow, which includes requirements, a functional design, a logical design, a physical design, a manufacturing design, and/or documentation.

In a block 802, the platform design analysis tool can generate tags corresponding to characteristics of objects in the designs. Each of the designs—the requirements, the functional design, the logical design, the physical design, the manufacturing design, and/or the documentation—can include taggable objects corresponding to portions of the designs, which the platform design tool can utilize to generate the tags. In some embodiments, the platform design analysis tool can define which portions of the designs correspond to the taggable objects.

In a block 803, the platform design analysis tool can index the tags. The indexing of the tags can include organizing the tags based on their level of abstraction, characteristics, object type, or the like, can include selecting which characteristics of the objects should be included in the tags, and, as discussed above, selectively merging tags from common levels of abstraction.

In a block 804, the platform design analysis tool can receive a selection corresponding to a portion in one of the designs. The platform design analysis tool can communicate with a user interface, which can allow for presentation design-related information and/or receipt of user input. In some embodiments, the selection corresponding to the portion in one of the designs can be user input received from the user interface, which, for example, can request the platform design analysis tool to generate a report or synchronize multiple designs.

In a block 805, the platform design analysis tool can query the index of the tags to identify a portion of another one of the designs associated with the selected portion. As discussed above, the platform design tool, for example, can query a memory system storing the tags to identify which of the objects in designs corresponding to different levels of abstraction relate to each other. The presence of related objects from designs in different levels of abstraction can correspond to a link between those designs.

In a block 806, the platform design analysis tool can present information corresponding to the identified portions associated with the selected portion. As discussed above, this information can be presented in one or more reports, such as a requirements tracing report, an impact assessment report, an equivalence check report, a design delta report, or the like.

### Illustrative Comparison and Synchronization Service for a Platform Design Analysis Tool

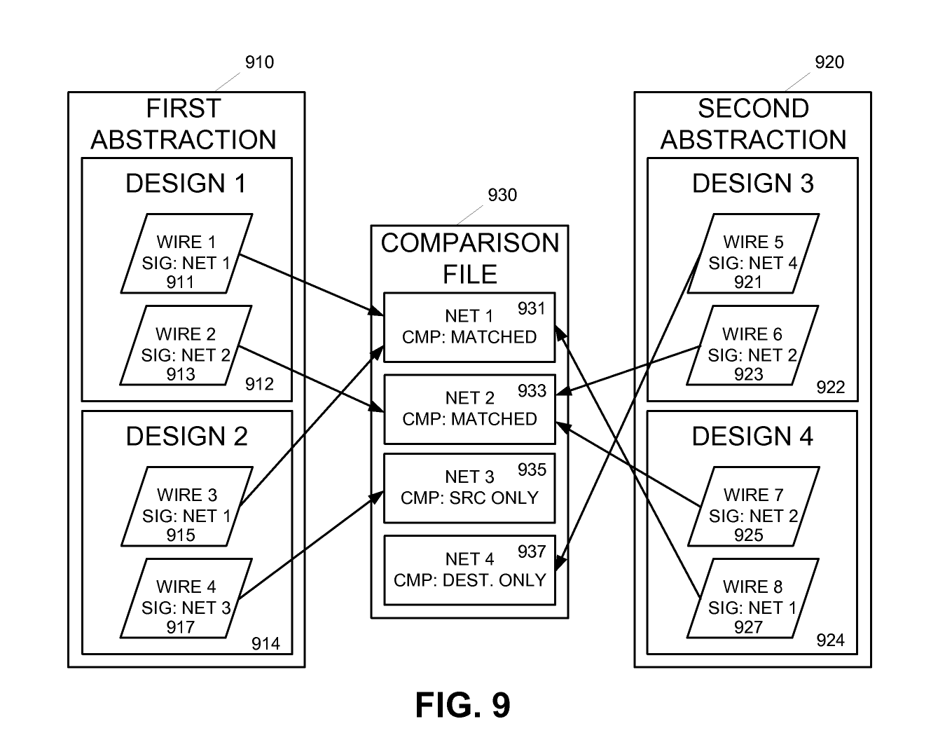

FIG. 9 illustrates an example implementation of a comparison service implemented in the platform design analysis tool according to various examples of the invention. Referring to FIG. 9, the platform design analysis tool implementing the comparison service can compare objects having been deemed to be related by their tags, for example, by a query service, to generate a comparison index or file. In some embodiments, the platform design analysis tool can store the index or file in a memory device, memory system, or other data storage device.

In this example, the platform design analysis tool can analyze or compare related objects of designs at different levels of abstraction. For example, from a first abstraction 910, the platform design analysis tool can receive objects 911 and 913 from design 912 and receive objects 915 and 917 from design 914. From a second abstraction 920, the platform design analysis tool can receive objects 921 and 923 from design 922 and receive objects 925 and 927 from design 924.

The platform design analysis tool implementing the comparison service can compare the related objects based on their characteristics and generate a comparison file 930 to identify which portions of the designs 912 and 914 in the first abstraction 910 match portions of the designs 922 and 924 in the first abstraction 920. Since the related objects can have many different characteristics, the comparison service can selectively determine which characteristic(s) it utilizes in the comparison of related objects. In some examples, the comparison service can analyze the tags to determine with objects it should compare. For sake of convenience of explanation, FIG. 9 shows a comparison of objects 911-927 based on net connectivity, i.e., which net or nets are associated with the wires in the designs 912, 914, 922, and 924. The comparison file 930 can indicate whether a match between related objects was made between the first and second abstractions 910 and 920. In some embodiments, the comparison file 930 can include records 931-937 for each characteristic utilized in the comparison along with a result of the comparison. For example, the records 931-937 can identify whether related objects matched across the first and second abstractions 910 and 920, and optionally, if they were unmatched, which of the first and second abstractions 910 and 920 failed to include a matching object, as shown in records 935 and 937.

The platform design analysis tool implementing the comparison service can utilize the comparison file 930 to generate various reports or other output. For example, the comparison service can generate one or more deltas based on the unmatched objects in the comparison file 930, generate a report corresponding to design equivalency based on the records 931-937 in the comparison file 930, or the like.

In some embodiments, the comparison service can utilize the records 931-937 in the comparison file 930 and the designs 912, 914, 922, and 924 to determine how one or more of the designs can be altered in order to render them congruent or equivalent, which the comparison service can include in one of its reports. When the platform design analysis tool includes a synchronization service, the comparison service can specially configure the delta to be executable, for example, including instructions that, when executed by the synchronization service, cause the synchronization service to automatically alter the designs as determined by the comparison service.

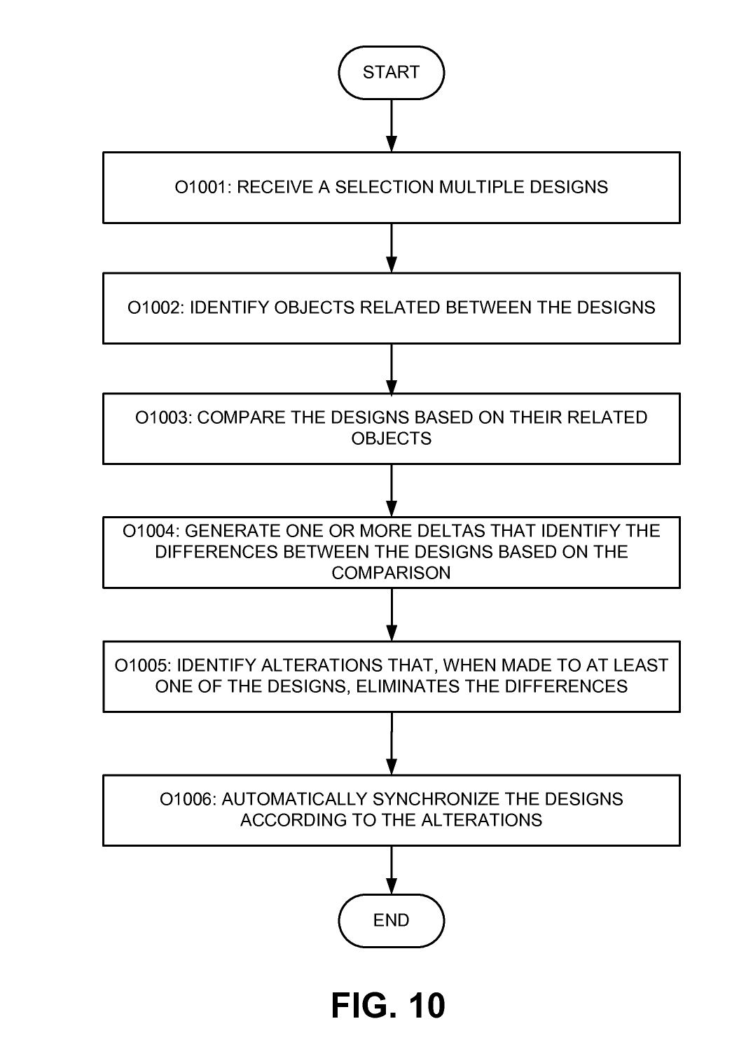

FIG. 10 illustrates a flowchart showing example operation of the comparison service and a synchronization service in a platform design analysis tool according to various examples of the invention. Referring to FIG. 10, in a block 1001, the platform design analysis tool, for example, implemented by a specifically programmed computing system, can receive a selection multiple designs. The platform design analysis tool can communicate with a user interface, which can allow for presentation design-related information and/or receipt of user input. In some embodiments, the selection of the multiple designs can be user input received from the user interface, which, for example, can request the platform design analysis tool to generate a report or synchronize the multiple designs.

In a block 1002, the platform design analysis tool can identify objects related between the designs. In some embodiments, the platform design analysis tool can prompt a query service to query a tag index or other storage repository of tags to identify objects corresponding to the tags that can be deemed or inferred to be related based on having common characteristics. Since the characteristics utilized to determine whether objects are related can be programmable or selectable, the platform design analysis tool, in some embodiments, can determine which characteristics to utilize when attempting to relate objects based on the user input corresponding to the selection of the multiple designs.

In a block 1003, the platform design analysis tool can compare the designs based on their related objects. As discussed above, the platform design analysis tool can compare the related objects between designs to determine whether certain characteristics match or not.

In a block 1004, the platform design analysis tool can generate one or more deltas that identify the differences between the designs based on the comparison. When the comparison of the related objects identifies one or more objects not having a match to another object corresponding to a design at a different level of abstraction, the platform design analysis tool can generate the delta to identify the lack of the match or a difference between related objects that rendered it unmatched.

In some embodiments, the platform design analysis tool can compare the designs for verification purposes, such as equivalence checking, design rule checking, or the like. Based on this comparison, the platform design analysis tool can generate a report that indicates or identifies whether two or more designs at different levels of abstraction are equivalent to each other.

In a block 1005, the platform design analysis tool can identify alterations that, when made to at least one of the designs, eliminates the differences. In some embodiments, the platform design analysis tool can analyze the differences between the designs based on whether related objects matched each other and determine how at least one of the designs can be altered in order to render them congruent. Since there can be multiple ways to eliminate a difference between designs, the platform design analysis tool, in some embodiments, can utilize a master-slave relationship to determine how to alter designs based on the deltas. For example, when two designs have an unmatched source object, meaning a design in a higher-level of abstraction includes a feature not present in a design in a low-level of abstraction, the platform design analysis tool can determine whether to alter the design in the higher-level of abstraction, or the design in the low-level of abstraction, or both. By specifying which level of abstraction has priority or is a master, the platform design analysis tool attempt to propagate changes in the appropriate direction.

In a block 1006, the platform design analysis tool can automatically synchronize the designs according to the alterations. As discussed above, the platform design analysis tool can generate the delta to include instructions that, when executed, can automatically effectuate the alterations identified in block 1005.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above, it should be appreciated that various examples of the invention may be implemented using any desired combination of electronic design automation processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
generating, by a computing system, tags corresponding to characteristics of objects in one or more designs representing at least a portion of an electronic system;
linking, by the computing system, the objects in the one or more designs based, at least in part, on tags; and
in response to receiving a selection corresponding to a portion of the one or more designs, presenting, by the computing system, information corresponding to at least another portion in the one or more designs associated with the selected portion based, at least in part, on the linked objects.

2. The method of claim 1 further comprising:
identifying, by the computing system, a first set of the objects is correlated to the selected portion; and
determining, by the computing system, a second set of the objects corresponding to one or more requirements of the electronic system is linked to the first set of the objects based, at least in part, on the linked objects, wherein presenting the information further comprises presenting the one or more requirements of the electronic system at least partially implemented by the selected portion.

3. The method of claim 1, wherein the selection corresponding to the portion of the one or more designs further comprises a change to the selected portion, the method further comprising determining an impact of the change to the selected portion on the at least another portion in the one or more designs associated with the selected portion based, at least in part, on the linked objects.

4. The method of claim 1, wherein linking the objects further comprises:
merging a plurality of the tags within the designs into complex tags based on their underlying characteristics; and
utilizing the complex tags to identify which of the objects in one or more of the designs are linked to other one or more of the objects in one or more of the designs.

5. The method of claim 1, wherein the electronic system is a wiring harness.

6. The method of claim 1, wherein the one or more designs includes multiple designs, each representing at least a portion of an electronic system at a different level of abstraction, wherein linking the objects further comprises linking designs across levels of abstraction based on the tags.

7. The method of claim 6, wherein the different levels of abstraction include one or more of a requirements level of abstraction, a functional level of abstraction, a logical level of abstraction, a physical level of abstraction, a manufacturing level of abstraction, or a documentation level of abstraction.

8. A system comprising:
a memory system configured to store computer-executable instructions; and
a computing system, in response to execution of the computer-executable instructions, is configured to:
generate tags corresponding to characteristics of objects in one or more designs representing at least a portion of an electronic system;
link the objects in the one or more designs based, at least in part, on tags; and
in response to receiving a selection corresponding to a portion of the one or more designs, present information corresponding to at least another portion in the one or more designs associated with the selected portion based, at least in part, on the linked objects.

9. The system of claim 8, wherein the computing system, in response to execution of the computer-executable instructions, is further configured to:
identify a first set of the objects is correlated to the selected portion;
determine a second set of the objects corresponding to one or more requirements of the electronic system is linked to the first set of the objects based, at least in part, on the linked objects; and
present the one or more requirements of the electronic system at least partially implemented by the selected portion.

10. The system of claim 8, wherein the selection corresponding to the portion of the one or more designs further comprises a change to the selected portion, and wherein the computing system, in response to execution of the computer-executable instructions, is further configured to determine an impact of the change to the selected portion on the at least another portion in the one or more designs associated with the selected portion based, at least in part, on the linked objects.

11. The system of claim 8, wherein the computing system, in response to execution of the computer-executable instructions, is further configured to:
merge a plurality of the tags within the designs into complex tags based on their underlying characteristics; and
utilize the complex tags to identify which of the objects in one or more of the designs are linked to other one or more of the objects in one or more of the designs.

12. The system of claim 8, wherein the electronic system is a wiring harness.

13. The system of claim 8, wherein the one or more designs includes multiple designs, each representing at least a portion of an electronic system at a different level of abstraction, wherein linking the objects further comprises linking designs across levels of abstraction based on the tags.

14. The system of claim 13, wherein the different levels of abstraction include one or more of a requirements level of abstraction, a functional level of abstraction, a logical level of abstraction, a physical level of abstraction, a manufacturing level of abstraction, or a documentation level of abstraction.

15. An apparatus comprising at least one computer-readable memory device storing instructions configured to cause one or more processing devices to perform operations comprising:
generating tags corresponding to characteristics of objects in one or more designs representing at least a portion of an electronic system;
linking the objects in the one or more designs based, at least in part, on tags; and
in response to receiving a selection corresponding to a portion of the one or more designs, presenting information corresponding to at least another portion in the one or more designs associated with the selected portion based, at least in part, on the linked objects.

16. The apparatus of claim 15, wherein the instructions are configured to cause one or more processing devices to perform operations further comprising:
identifying a first set of the objects is correlated to the selected portion; and
determining a second set of the objects corresponding to one or more requirements of the electronic system is linked to the first set of the objects based, at least in part, on the linked objects, wherein presenting the information further comprises presenting the one or more requirements of the electronic system at least partially implemented by the selected portion.

17. The apparatus of claim 15, wherein the selection corresponding to the portion of the one or more designs further comprises a change to the selected portion, the method further comprising determining an impact of the change to the selected portion on the at least another portion in the one or more designs associated with the selected portion based, at least in part, on the linked objects.

18. The apparatus of claim 15, wherein linking the objects further comprises:
merging a plurality of the tags within the designs into complex tags based on their underlying characteristics; and
utilizing the complex tags to identify which of the objects in one or more of the design are linked to other one or more of the objects in one or more of the designs.

19. The apparatus of claim 15, wherein the one or more designs includes multiple designs, each representing at least a portion of an electronic system at a different level of abstraction, wherein linking the objects further comprises linking designs across levels of abstraction based on the tags.

20. The apparatus of claim 19, wherein the different levels of abstraction include one or more of a requirements level of abstraction, a functional level of abstraction, a logical level of abstraction, a physical level of abstraction, a manufacturing level of abstraction, or a documentation level of abstraction.
